(19) United States
(12) Patent Application Publication
(10) Pub. No.: US 2021/0317912 A1
(43) Pub. Date: Oct. 14, 2021

(54) Shift Mechanism for a Gearbox

(71) Applicant: KNORR-BREMSE SYSTEME FUER NUTZFAHRZEUGE GMBH, Muenchen (DE)

(72) Inventors: Sebastian SCHALLER, Langweid (DE); Martin KRAL, Muenchen (DE); Juergen SCHUDY, Muenchen (DE)

(21) Appl. No.: 17/264,642

(22) PCT Filed: Jul. 10, 2019
(86) PCT No.: PCT/EP2019/068607

§ 371 Date: Jan. 29, 2021

(30) Foreign Application Priority Data
Jul. 30, 2018 (DE) 10 2018 212 697.6

(51) Int. Cl. F16H 61/30; F16H 61/32; F16H 63/08; F16H 63/24; F16H 63/32

(52) U.S. Cl. CPC F16H 61/30; F16H 61/32; F16H 2063/321; F16H 63/24; F16H 63/32; F16H 63/08

(57) ABSTRACT

A shift mechanism for a gearbox has a shift actuation unit designed to produce an axial shifting motion, at least two selector forks for shifting gear components to shift gears, and at least one shift rod designed to transmit the axial shifting motion from the shift actuation unit to at least one of the at least two selector forks. The coupling mechanisms and the shift rods are positioned to be axially aligned with one another.

### BACKGROUND AND SUMMARY OF THE INVENTION

The invention relates to a gear-shifting mechanism for a transmission, in particular a gear-shifting mechanism for a manual transmission of a vehicle.

Gear-shifting mechanisms for transmissions, which carry out a shifting of gears by shift rods in a manual transmission so as to by way of specific shift forks displace transmission components, for example gear wheels or drivers, are known. The shift rods are usually disposed in a direction parallel to transmission shafts of the transmission, as well as disposed so as to be mutually parallel beside one another.

Since the shift rods, as stated above, are disposed so as to be mutually parallel beside one another in the direction of the transmission shafts, said shift rods consume a large installation space which is becoming ever scarcer, in particular when taking into account an increasing number of construction modules and components.

The invention is thus based on the object of providing a gear-shifting mechanism and a method for shifting for a transmission which eliminate the above disadvantage, wherein the shifting mechanism is to have a compact construction mode.

The object is achieved by a gear-shifting mechanism and by a method in accordance with the independent claims. Advantageous refinements of the invention are the subject matter of the dependent claims.

According to one aspect of the invention, a gear-shifting mechanism for a transmission has a shift activation unit which is configured for generating an axial shifting movement, at least two shift forks for displacing transmission components for shifting gears, at least one shift rod which is configured for transmitting the axial shifting movement from the shift activation unit to at least one of the at least two shift forks, and at least two coupling mechanisms for selectively establishing a mechanical coupling between the shift activation unit and one of the at least two shift forks.

A construction which saves installation space is possible by providing the at least two coupling mechanisms and the at least one shift rod, since a plurality of shift forks can be selectively moved by the one shift rod without the installation space lateral to the shift rod being enlarged by providing shift rods lying beside one another.

In one advantageous refinement of the gear-shifting mechanism, the coupling mechanisms and the shift rods are disposed so as to be axially mutually aligned, thus mutually aligned along one axis.

Such an arrangement offers the largest potential savings in terms of required installation space.

In one advantageous refinement of the gear-shifting mechanism, at least two shift rods are provided; the shift forks are in each case connected to one of the at least two shift rods, and the at least two coupling mechanisms are configured for establishing in each case one mechanical coupling between the shift activation unit and one of the at least two shift rods.

By providing the at least two shift rods and in each case one coupling mechanism, the coupling mechanisms can be combined at one location because the shift forks can be disposed on shift rods of dissimilar lengths, this facilitating an actuation. The coupling mechanisms herein can be provided in one common housing.

In one advantageous refinement, the at least two shift rods are disposed so as to be mutually coaxial.

Further effective saving in terms of installation space is possible on account of this arrangement, since the shift rods can be disposed inside one another such that said shift rods are not disposed beside one another.

In one alternative advantageous refinement, the shift rod is connected to the shift activation unit, and the at least two coupling mechanisms are configured for establishing in each case one mechanical coupling between the at least one shift rod and one of the at least two shift forks.

Here there is the possibility of locally allocating the coupling mechanisms to the shift forks. Hence the local installation space required to this end is not so large, such that a required installation space for the gear-shifting mechanism can be designed in a more favorable manner.

In one advantageous refinement, the shift activation unit has a shift activation actuator which is movable along a shift activation axis, and the at least one shift rod and the at least two coupling mechanisms are disposed so as to be in alignment with the shift activation axis.

This arrangement enables a further saving in terms of installation space.

In one advantageous refinement, the at least two coupling mechanisms each have coupling elements which are configured for establishing a force-fitting connection between the shift activation unit and one of the at least two shift rods, or between the at least one shift rod and one of the at least two shift forks.

The coupling elements can establish a force-fitting connection in a simple manner, for example by mutual rotation or by one of the coupling elements expanding in relation to another one of the coupling elements.

In one alternative advantageous refinement, the at least two coupling mechanisms each have coupling elements which are configured for establishing a form-fitting connection between the shift activation unit and one of the at least two shift rods, or between the at least one shift rod and one of the at least two shift forks.

The coupling elements can in a simple manner establish a form-fitting connection which transmits the shifting movement in a more reliable manner, for example by mutual rotation or by one of the coupling elements expanding in relation to another one of the coupling elements.

In one advantageous refinement, the coupling elements are configured for establishing the form-fitting connection according to the principle of a bayonet fitting.

The coupling elements according to the principle of the bayonet fitting enable simple and reliable coupling in order for the shifting movement to be transmitted in both axial directions.

The gear-shifting mechanism can in each case be actuated in a simple and/or cost-effective manner depending on the environmental conditions, the overall conditions, etc. when the gear-shifting mechanism alternatively has a pneumatically activatable shift activation actuator, a hydraulically activatable shift activation actuator, an electrically activatable switchover actuator, or an electro-mechanically activatable switchover actuator.

According to another aspect of the invention, a method for shifting a gear in a transmission by way of the gear-shifting mechanism comprises the following steps: establishing the mechanical coupling between the shift activation unit and one of the at least two shift rods; or establishing the mechanical coupling between the at least one shift rod and one of the at least two shift forks; and activating the shift activation unit so as to establish a gear-specific connection within the transmission by way of the specific shift fork.

The mutual axial alignment of the coupling mechanisms and the shift rods is possible by this method in which the at least one shift rod and the at least two shift forks are coupled for a gear-specific connection, such that a construction which saves installation space is possible.

In one advantageous refinement of the method, the establishing of the mechanical coupling takes place by mutually rotating coupling elements.

It is easily possible to establish a force-fitting of form-fitting connection on account of the rotation.

A force-fitting connection can be established in a simple manner without any additional or specially shaped components when the mechanical coupling, as in one advantageous refinement of the method, is established by applying a torque to one of the coupling elements, said torque acting about a shift rod axis.

The invention will now be explained by means of exemplary embodiments with reference to the appended drawings.

### BRIEF DESCRIPTION OF THE DRAWINGS

FIG. 1 is a diagram of an embodiment of a gear-shifting mechanism according to the invention;

FIG. 2 is a diagram of another embodiment of the gear-shifting mechanism according to the invention; and

FIG. 3 is a flow chart of an exemplary method for shifting a gear by way of the gear-shifting mechanism according to an embodiment the invention.

### DETAILED DESCRIPTION OF THE DRAWINGS

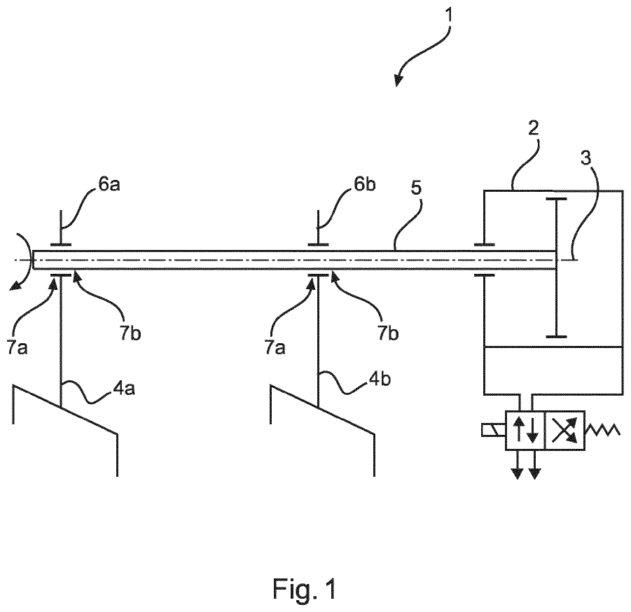

FIG. 1 shows a diagram of an embodiment of a gear-shifting mechanism 1. The gear-shifting mechanism 1 has a shift activation unit 2 which generates an axial shifting movement. The shift activation unit 2 has a pneumatically activatable shift activation actuator. In alternative embodiments, the shift activation unit 2 has a hydraulically activatable shift activation actuator, an electrically activatable shift activation actuator, or an electro-mechanically activatable shift activation actuator. The shift activation actuator is movable along a shift activation axis 3 so as to generate the axial shifting movement.

The gear-shifting mechanism 1 furthermore has two shift forks 4a, 4b. The shift forks 4a, 4b displace transmission components so as to shift gears in the transmission. More than two shift forks 4a, 4b may also be provided in alternative embodiments.

Moreover provided in the gear-shifting mechanism 1 is a shift rod 5 which transmits the axial shifting movement from the shift activation unit 2 to the two shift forks 4a, 4b. To this end, the shift rod 5 is connected to the shift activation unit 2.

The gear-shifting mechanism 1 furthermore has two coupling mechanisms 6a, 6b. A mechanical coupling between the shift activation unit 2 and one of the two shift forks 4a, 4b can in each case be established optionally by way of these two coupling mechanisms 6a, 6b. Here, only one of the shift forks 4a, 4b or both of the shift forks 4a, 4b can be connected to the shift activation unit 2 by way of the shift rod 5. In the alternative embodiment having more than two shift forks 4a, 4b, a plurality of shift forks suitable for the desired shifting can thus be connected.

The coupling mechanisms 6a, 6b and the shift rod 5 are disposed so as to be mutually axially aligned, thus aligned along the shift activation axis 3, and are also disposed so as to be in alignment with the shift activation axis 3. In an alternative embodiment, the coupling mechanisms 6a, 6b and the shift rod 5 in a modified disposal of the shift activation unit 2 are not disposed so as to be in alignment or in a manner axial in relation to the shift activation axis 3, so as to on account of such a disposal of the shift activation unit 2 save further installation space, the shift activation unit 2 optionally being able to plunge into a void in the transmission.

The coupling mechanisms 6a, 6b each have coupling elements 7a, 7b by way of which a form-fitting connection between the shift rod 5 and the two shift forks 4a, 4b is in each case established. The form-fitting connection is established according to the principle of a bayonet fitting. A transmission of the axial shifting movement is possible in both directions on account of connection in the manner of the bayonet fitting. In alternative embodiments, the coupling elements 7a, 7b may also be designed in another shape so as to implement the form-fitting connection. For example, a collar which is provided so as not to be rotationally symmetrical on the shift rod 5 may be provided, and two inwardly directed walls having in each case one opening which is complementary to the non-rotationally symmetrical collar may be provided on the side of the shift fork 4a, 4b. The form-fitting connection is in this instance established when the collar is axially introduced between the two walls and the collar is rotated in relation to the walls.

In a further alternative embodiment, the coupling elements 7a, 7b can also be embodied for establishing a force-fitting connection between the shift rod 5 and in each case one of the two shift forks 4a, 4b. For example, a friction-fit between a protrusion on the shift rod 5 and a protrusion which on the shift fork 4a, 4b is directed toward the shift rod 5 can be generated here. Alternatively, expanding of one of the coupling elements 7a, 7b such that a frictional force is created between the coupling elements 7a, 7b is also possible.

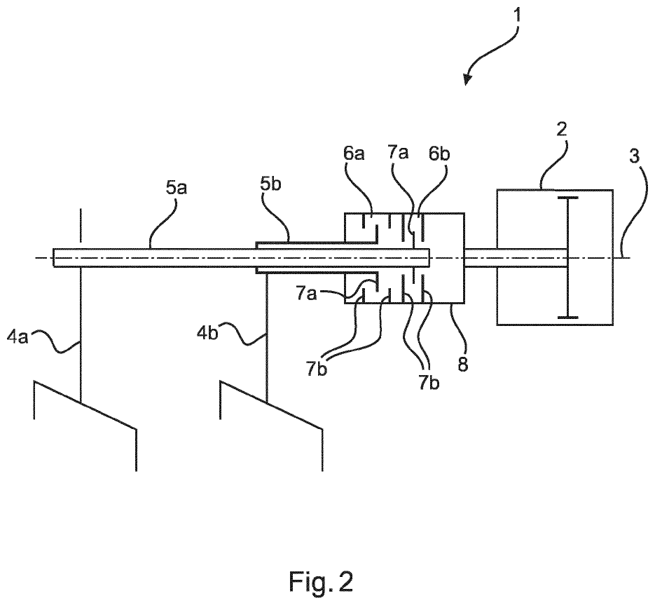

FIG. 2 shows a diagram of another embodiment of the gear-shifting mechanism 1 according to the invention. This embodiment differs from the embodiment of FIG. 1 in that two shift rods 5a, 5b are provided in this embodiment.

The points of differentiation in comparison to the embodiment shown in FIG. 1 are explained hereunder.

The coupling mechanisms 6a, 6b in this embodiment establish in each case a mechanical coupling between the shift activation unit 2 and the two shift rods 5a, 5b. To this end, the coupling mechanisms 6a, 6b also in this embodiment have the coupling elements 7a, 7b which establish a form-fitting connection, or alternatively a force-fitting connection, between the shift activation unit 2 and one of the at least two shift rods 5a, 5b, as has been described above. The coupling mechanisms 6a, 6b are disposed in a common housing 8. Alternatively, said coupling mechanisms 6a, 6b may also be disposed in separate housings or be without a special housing. The shift forks 4a, 4b in this embodiment are in each case connected to the shift rods 5a, 5b.

The two shift rods 5a, 5b are disposed so as to be mutually coaxial. Alternatively, the shift rods 5a, 5b can also be disposed behind one another in the axial direction.

The coupling mechanisms 6a, 6b and the shift rods 5a, 5b are disposed so as to be mutually axially aligned along the shift activation axis 3.

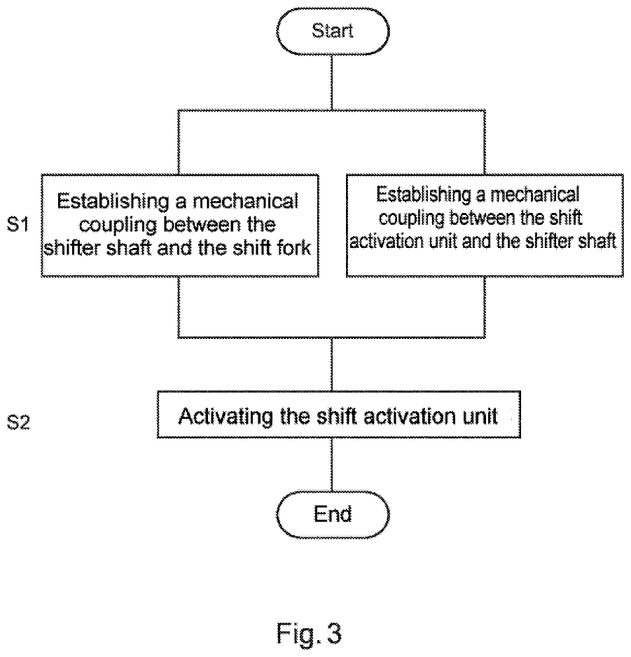

FIG. 3 shows a flowchart of a method for shifting a gear by way of the gear-shifting mechanism 1 according to the invention.

First, in step S1, the mechanical coupling between the shift rod 5 and one of the at least two shift forks 4a, 4b (FIG. 1), or between the shift activation unit 2 and one of the two shift rods 5a, 5b (FIG. 2), is established as a function of the embodiment of the gear-shifting mechanism 1.

Subsequently, in step S2, the shift activation unit 2 is activated so as to generate the axial shifting movement and to establish a gear-specific connection within the transmission by way of the specific shift fork 4a, 4b.

In one of the embodiments, the coupling elements 7a, 7b are mutually rotated so as to establish the mechanical coupling. Alternatively, a form-fitting or force-fitting coupling is generated here. Alternatively, the mechanical coupling takes place by applying a torque to one of the coupling elements 7a, 7b, said torque acting about a shift rod axis. Alternatively, either the form-fitting connection or the force-fitting connection can likewise be generated here.

All of the features illustrated in the description, the following claims and the drawing can be relevant to the invention individually as well as in any arbitrary combination with one another.

### LIST OF REFERENCE SIGNS

1 Gear-shifting mechanism
2 Shift activation unit
3 Shift activation axis
4a, 4b Shift fork
5, 5a, 5b Shift rod
6a, 6b Coupling mechanism
7a, 7b Coupling mechanism
8 Housing

1.-15. (canceled)

16. A gear-shifting mechanism for a transmission, comprising:
a shift activation unit which is configured for generating an axial shifting movement;
at least two shift forks for displacing transmission components for shifting gears;
at least one shift rod which is configured for transmitting the axial shifting movement from the shift activation unit to at least one of the at least two shift forks; and
at least two coupling mechanisms for selectively establishing a mechanical coupling between the shift activation unit and one of the at least two shift forks.

17. The gear-shifting mechanism as claimed in claim 16, wherein
the coupling mechanisms and the shift rods are disposed so as to be axially mutually aligned.

18. The gear-shifting mechanism as claimed in claim 16, wherein
at least two shift rods are provided,
the shift forks are in each case connected to one of the at least two shift rods, and
the at least two coupling mechanisms are configured for establishing in each case one mechanical coupling between the shift activation unit and one of the at least two shift rods.

19. The gear-shifting mechanism as claimed in claim 18, wherein
the at least two shift rods are disposed so as to be mutually coaxial.

20. The gear-shifting mechanism as claimed in claim 16, wherein
the shift rod is connected to the shift activation unit,
the at least two coupling mechanisms are configured for establishing in each case one mechanical coupling between the at least one shift rod and one of the at least two shift forks.

21. The gear-shifting mechanism as claimed in claim 16, wherein
the shift activation unit has a shift activation actuator which is movable along a shift activation axis, and
the at least one shift rod and the at least two coupling mechanisms are disposed so as to be in alignment with the shift activation axis.

22. The gear-shifting mechanism as claimed in claim 16, wherein
the at least two coupling mechanisms each have coupling elements which are configured for establishing a force-fitting connection between the shift activation unit and one of the at least two shift rods, or between the at least one shift rod and one of the at least two shift forks.

23. The gear-shifting mechanism as claimed in claim 16, wherein
the at least two coupling mechanisms each have coupling elements which are configured for establishing a form-fitting connection between the shift activation unit and one of the at least two shift rods, or between the at least one shift rod and one of the at least two shift forks.

24. The gear-shifting mechanism as claimed in claim 23, wherein
the coupling elements are configured for establishing the form-fitting connection via a bayonet fitting.

25. The gear-shifting mechanism as claimed in claim 16, wherein
the shift activation unit has a pneumatically activatable shift activation actuator.

26. The gear-shifting mechanism as claimed in claim 16, wherein
the shift activation unit has a hydraulically activatable shift activation actuator.

27. The gear-shifting mechanism as claimed in claim 16, wherein
the shift activation unit has an electrically activatable shift activation actuator or an electro-mechanically activatable shift activation actuator.

28. A method for shifting a gear in a transmission having a gear-shifting mechanism that comprises:
a shift activation unit which is configured for generating an axial shifting movement;
at least two shift forks for displacing transmission components for shifting gears;
at least one shift rod which is configured for transmitting the axial shifting movement from the shift activation unit to at least one of the at least two shift forks; and
at least two coupling mechanisms for selectively establishing a mechanical coupling between the shift activation unit and one of the at least two shift forks.
the method comprising the steps of:
establishing a mechanical coupling between the shift activation unit and one of the at least two shift rods; or
establishing a mechanical coupling between the at least one shift rod and one of the at least two shift forks; and
activating the shift activation unit so as to establish a gear-specific connection within the transmission by way of the specific shift fork.

29. The method as claimed in claim 28, wherein
the establishing of the mechanical coupling takes place by mutually rotating coupling elements.

30. The method as claimed in claim 29, wherein
the establishing of the mechanical coupling takes place by applying a torque to one of the coupling elements, said torque acting about a shift rod axis.
